(19) United States
(12) Patent Application Publication
(10) Pub. No.: US 2006/0054203 A1
(43) Pub. Date: Mar. 16, 2006

(54) Apparatus for cleaning collets used in the production of fiberglass

(76) Inventor: Larry Kenneth Ray, Amarillo, TX (US)

Correspondence Address: SAMUEL BROWN SILVERMAN, 510 S. POLK STREET, AMARILLO, TX, 79101-2318, US

(21) Appl. No.: 10/941,311

(22) Filed: Sep. 14, 2004

(51) Int. Cl. B08B 3/00; B08B 3/12

(52) U.S. Cl. 134/172; 134/34; 134/198

(57) ABSTRACT

The apparatus of this invention is used to clean a collet, the generally cylindrical hub of a fiberglass filament winding machine. The apparatus consists of at least one high-pressure fluid-spraying nozzle, an extensible arm, a drive means, a high pressure fluid source, and a means for rotating the collet. One or more nozzles are mounted on a movable platform, which is itself mounted on the end of an extensible arm. The drive means moves the extensible arm to positions over the collet, and a high pressure fluid source provides cleansing fluid to the one or more nozzles. Additionally, a turning means rotates the collet to effect cleaning of the surface. The method of this invention provides for cleaning a collet, the hub of a fiberglass filament winding machine. The method consists of positioning an extensible arm, by a drive means, over the collet. The position of the extensible arm may be along a line of travel parallel to the axis of the collet. At the end of the arm is a movable platform with one or more nozzles. Then, the exterior surface of the collet is sprayed at close proximity with a high-pressure fluid. The exterior surface of the collet is thereby cleaned with the high pressure fluid expelled from one or more nozzles while the collet is rotated on its axis.

### 1. FIELD OF THE INVENTION

The present invention is directed, in certain embodiments, to an apparatus for cleaning the surface of a collet, which supports one or more cylindrical elements upon which fiberglass filament made from fiberglass fiber is wound onto spools.

### 2. BACKGROUND OF THE INVENTION

In the production of fiberglass, it is customary to produce a continuous filament of fiberglass fiber which is spun and wound onto a cylindrical element, or spool. Each cylindrical element or spool is generally made from pressboard or cardboard and has a longitudinal axis through its radius. One or more cylindrical elements or spools is mounted on a collet, the exterior surface of which firmly engages the interior surface of each cylindrical element or spool. The process of making fiberglass filaments employs linearly orienting fiberglass filaments, which are held together by a binder. In the process of winding the generally continuous fiberglass filament on the cylindrical element or spool, the generally cylindrical collet spins around a common longitudinal axis shared with the spool. The exterior surface of the collet is generally covered by the cylindrical element of each spool, and ideally, should not have any contact with the fiberglass fiber, binder or one or more filaments being spun. One of the primary purposes of conveying the filament onto the collet is to spool the filament in a controlled pattern thereon. The length of filament spun, deposited and wound on each spool is mechanically predetermined. After each spool has the appropriate length of fiber, each of the full spools is removed from the collet by sliding the cylindrical element or spools off the collet.

In practice, the exterior surface of the collet is contaminated by loose fibers or resin. The mechanical production of fiberglass filament is continuous. Over the course of operation in a day, when dozen or hundreds of cylindrical elements or spools are mounted and removed, the exterior surface of the collet becomes increasingly contaminated by one or more layers of deposits, composed of one or more fibers, one or more filament elements, or binder. Tiny particles of binder seep through the fiberboard spindle and onto the collet upon which the spindle is mounted.

The placement and removal of the cylindrical elements or spools becomes difficult. The spindles therefor acquire uneven and crusty deposits of their surfaces which impair the mobility of the spindle. Additionally, a cylindrical element or spool is damaged in the course of removal, thus adversely affecting the quality of the spool.

As the spindles are wound quickly, the ability to quickly remove the old spindle from the collet and remount the new spindle onto the collet is an important part of the productivity of the fiberglass filament making process. Thus, each contaminated collet impairs the timely and efficient removal of the cylindrical elements or spool, thus impairing production of fiberglass fiber.

Collets require regular cleaning. Currently, it is common to clean the exterior surface of each collet by an operator spraying an aqueous solution or water under pressure, usually 10,000 to 20,000 p.s.i., by means of a manually-operated wand or water gun. During the time that the collet is cleaned in this fashion, the entire fiberglass winding apparatus is not in production. Furthermore, because the quality of cleanliness of a collet depends on both the judgment and perceptions of the operator cleaning the collet, the quality and consistency of the cleaning of the surface of the collet is irregular. While it is given that the exterior surface of a collet will require regular cleaning, the cleanliness of the surface will affect the productivity of that collet and the apparatus upon which it is mounted between cleanings.

Prior art cleaning apparatuses do not satisfactorily address the problem of cleaning a collet in the mechanical production of fiberglass fiber. The closest prior art for fiberglass or glass production teaches that cleaning of a cylindrical element is effected by sliding a brush or burnishing element along the element to be cleaned.

Currently, the commonly employed apparatuses for cleaning collets in the production of fiberglass filament and continuous fibers do not address these problems.

Until this invention, no comparable apparatus and method of using the same has been available which address the problems of cleaning the exterior contact surface of a collet.

### 3. DESCRIPTION OF RELEVANT PRIOR ART PATENTS

Various cleaning apparatuses pertaining to glass production as well as other art in certain prior art embodiments describe and claim specific structures for varied purposes.

In U.S. Pat. Nos. 4,208,754, and 6,170,293, conveyor rolls used in the production of glass are rotatably mounted on a supporting frame while a brushing element engages the conveyor rolls to remove the encrustations. The brushing element slides along a path parallel to the longitudinal axes of the rolls being cleaned.

In U.S. Pat. No. 6,210,082, the surface of a diametral surface of a glass mold is mounted in a stationary position while a rotating reaming tool contact the surface of the mold.

U.S. Pat. No. 1,517,961, is an apparatus for cleaning a warping machine, or loom, by use of a pneumatic jet. The air blows lint off the separate yarns or filaments. The jet operates on a track at a set distance from the loom or the filaments being affected so as to keep the front and back combs, drop-wires, and other parts of the drop-wires free and clear from lint.

U.S. Pat. No. 3,337,320 is a process for removing deposits from glass-engaging rolls by applying a hot gas and moisture combination under pressure. The temperature range described is above 200 degrees Fahrenheit with a pressure range above 25 p.s.i.

U.S. Pat. No. 3,999,239 describes an apparatus for cleaning printing rollers. Rollers used in the printing process are rotatably mounted on a supporting frame while a sandpaper or wire brushing element engages the rolls to remove encrustations. The brushing element slides along a path parallel to the longitudinal axes of the rolls being cleaned. In combination therewith, a showering device and a blade wash and dry the roller being cleaned.

### 4. SUMMARY OF THE INVENTION

The present invention overcomes the aforementioned problems by utilizing a mobile apparatus operable outside of and positionable near the collect to the cleaned. In one embodiment, the cleaning apparatus comprises a mobile lower main unit, with an element for rotatably mounting against and engaging the end of a collet, and an longitudinally extensible upper element, upon which at least one rotating nozzle is positioned over the rotating surface of the collet for cleaning.

This apparatus of the invention is an improved collet cleaning apparatus consisting of: (1) at least one high-pressure fluid-spraying nozzle for spraying an exterior surface of a collet, the high pressure fluid spraying nozzle mounted on a movable platform; (2) an extensible arm, attached to the movable platform; (3) a drive means for moving the extensible arm; (4) a high pressure fluid source for providing fluid under high pressure to the at least one high-pressure fluid spraying nozzle; and, (5) a means for rotating the collet.

This method of the invention is a method for cleaning a collet wherein: (1) at least one high-pressure fluid-spraying nozzle for sprays an exterior surface of a collet, wherein the high pressure fluid spraying nozzle is mounted on a movable platform; (2) an extensible arm, attached to the movable platform, positions the at least one high-pressure fluid-spraying nozzle for spraying fluid at one or more specific points on the exterior surface of a collet; (3) a drive means moves the extensible arm; (4) a high pressure fluid source for provides fluid under high pressure to the at least one high-pressure fluid spraying nozzle; and, (5) a means rotates the collet around a longitudinal axis.

In one embodiment, the cleaning apparatus comprises a mobile lower main unit, with an element for rotatably mounting against and engaging the end of a collet, and an longitudinally extensible upper element, upon which at least one rotating nozzle is positioned over the rotating surface of the collet for cleaning.

The main object of this invention is to provide a high pressure cleaning apparatus for cleaning the collet employed in the production of fiber glass filaments to a substantially original condition.

Another object of this invention is to provide a cleaning apparatus that is simple in construction, easily used, and which reduces the time required for cleaning the collect.

Yet another object of this invention is to provide a cleaning apparatus for cleaning the supporting surfaces of the winding machines wherein the downtime of the fiberglass-fiber filament winding production is minimized due to the requisite cleaning required to maintain the productivity and efficiency of the collet component of said winding machines.

This invention addresses the problems which frequently arise pertaining to: (1) the difficulty in cleaning a collet in a fiberglass-fiber filament winding machine and process; (2) the thorough cleaning of a collet without exposing operators to further risk of personal injury from manually operating high-pressure cleaning wands; and (3) thoroughly cleaning the surfaces of a collet while minimizing damage to the cleaning equipment and filament-winding equipment.

This invention presents three primary advantages. The first advantage arises from the consistency in cleaning the exterior surface (12) of the collet (11). Currently, many fiberglass-filament winding facilities employ individuals to hold water guns to spray the surface of the collet with a high pressure fluid. While experience teaches many operators how to visually ascertain a suitable level of cleanliness, it is not necessarily the case that the entire surface of each collet is cleaned adequately. Furthermore, because the splashback from the spray is not necessarily controlled, it is possible that debris from one part of the exterior surface (12) of the collet (11) is merely transferred to another part of the surface, or even from another machine. This invention addresses a need in the industry not previously or adequately addressed by providing a consistent cleaning application along the entire surface of the collet.

The second advantage of this invention relates to enhancing productivity of the fiberglass filament winding machines (61). Currently, many fiberglass-filament winding facilities operate numerous winding machines simultaneously. In the course of the cleaning of the machines, it is currently desirable to shut down numerous machines, as the commonly employed time-consuming procedure of having an operator aim a water gun at a collet interferes with the operations of nearby winding machines. The apparatus and method of this invention permits the relatively faster and facile cleaning of a collet without interfering with the operation of nearby fiberglass filament-winding machines. By operating faster than what is currently employed in the industry, as well as operating faster than the commonly employed procedures, this invention enhances productivity.

The third advantage of this invention in both its apparatus and process relates to the enhancement of the safety to the personnel who clean collets. The commonly employed procedure of having an operator hold a water gun which emits water under pressure between 5 Kpsi to 40 Kpsi exposes the operator some risk from operating high pressure equipment as well as the splash-back from debris located on the exterior surface (12) of the collet (11). While elements of pressboard from the spool (62) hitting an operator at high velocity may be annoying, shards of fiberglass fibers, or hardened binder and filaments at high velocity do present hazards even to the operator in appropriate safety attire. Furthermore, by not having a continuous mist in the region of the operator and the winding machine (60), there is less water upon which operators or other employees to slip on in the workplace. Thus, the opportunity for injury and potential injury is lessened as a result of the use of this invention.

These and other objects and advantages of the present invention, as well as details of the preferred embodiment, and other embodiments thereof, will be more fully understood from the following description and the drawings.

### 5. BRIEF DESCRIPTION OF THE DRAWINGS

In the drawings wherein like numerals are employed to designate the like parts throughout the same:

FIG. 1 is a exploded prospective view of one version of the collect cleaning apparatus constructed in accordance with the invention.

FIG. 2 is a side elevation view of the assembled cleaning apparatus shown in FIG. 1.

FIG. 3 is an enlarged cross-sectional view taken substantially along 3-3 of FIG. 2 illustrating the collet rotating drive mechanism.

FIG. 4 is an enlarged fragmentary view of the movable platform demonstrating the relationship of the impeller with the high pressure fluid spraying nozzles over the exterior surface of a collet.

FIG. 5 is a diagram of the extended arm over the collet.

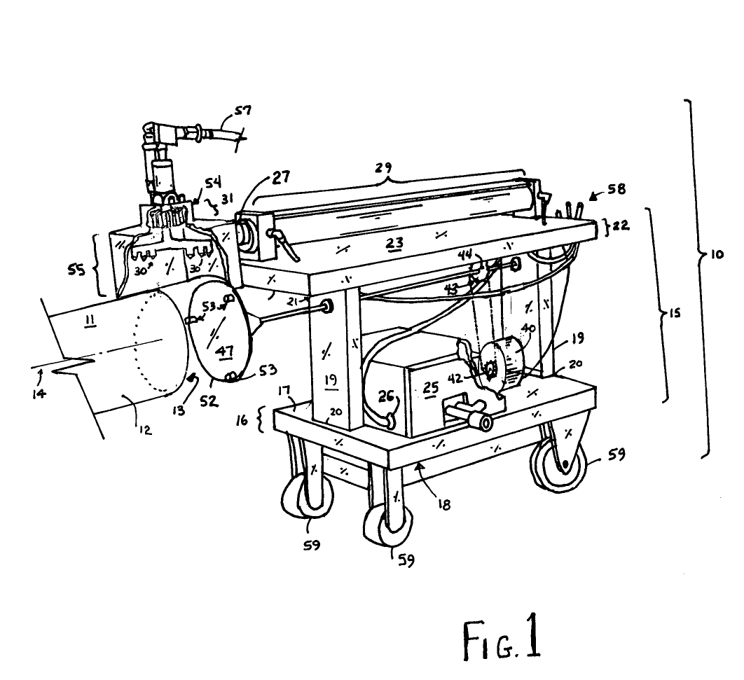

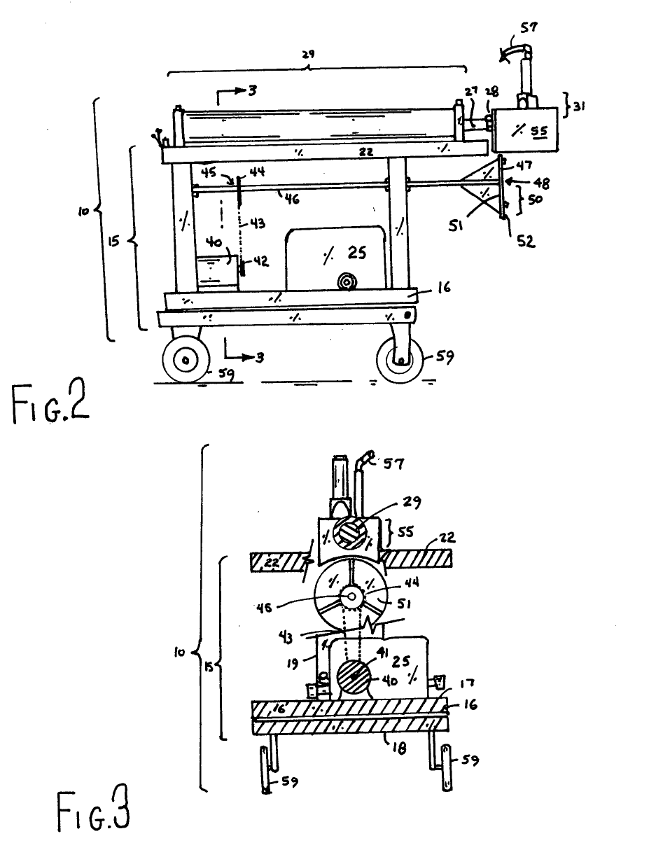

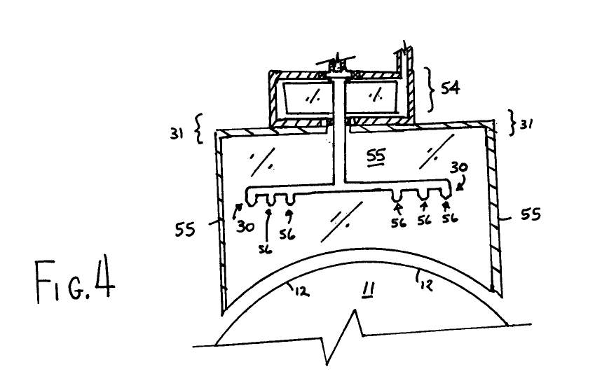

### 6. DESCRIPTION OF CERTAIN PREFERRED EMBODIMENTS

This invention is an improved collet-cleaning apparatus (10). A collet (11) is the generally cylindrical hub of a fiberglass filament winding machine (60). A generally cylindrical element, or spool (62), is snugly mounted on the collet (11). The fiberglass filament (63) is wound on the spool (62) as the collet (11) turns in the course of its normal operation. After numerous uses, deposits of fiberglass filament (63), or its constituent fiberglass fibers and binder, as well as constituent pressboard pieces of the spool (62) remain and cake on the exterior surface (12) of the collet (11). In the course of regular maintenance, the exterior surface (12) of the collet (11) requires cleaning.

As illustrated in the drawings, this invention is an improved collet cleaning apparatus (10) consisting of at least one high-pressure fluid-spraying nozzle (30), an extensible arm (27), a drive means (29) for moving the extensible arm (27), a high pressure fluid source (25), and a means (32) for rotating the collet (11).

The at least one high-pressure fluid-spraying nozzle (30) is for spraying an exterior surface (12) of a collet (11).

In one embodiment, the at least one high-pressure fluid-spraying nozzle (30) is mounted on a movable platform (31). The high pressure fluid spraying nozzle (30) is positioned at a distance of 0.05″ to 2.00″ over the surface of the collet (11). Additionally, the angle at which the fluid is expelled from the nozzle need not be generally perpendicular to the exterior surface (12) of the collet (11). By having the fluid simultaneously strike the exterior surface (12) of the collet (11) at a variety of angles simultaneously, cleaning is better effected by having a plurality of discrete areas impacted at a variety of angles applied to each part of the exterior surface (12) as the collet (11) turns.

The high pressure fluid spraying nozzle (30) is in fluid communication with the outlet (26) of the high pressure fluid source (25). As shown in the drawings, at least one hydraulic line (57) connects the outlet (26) to the nozzle (30). The flow of fluid is controlled by a control switch (58). In the embodiment disclosed, the switch (57) is a three-way valve.

The extensible arm (27) is attached to the movable platform (31). In one preferred embodiment, the extensible arm (27) has a distal end (28) on which his mounted The movable platform (31) is mounted on the distal end (28) of the extensible arm (27).

The movable platform (31) supports the at least one high-pressure fluid-spraying nozzle (30).

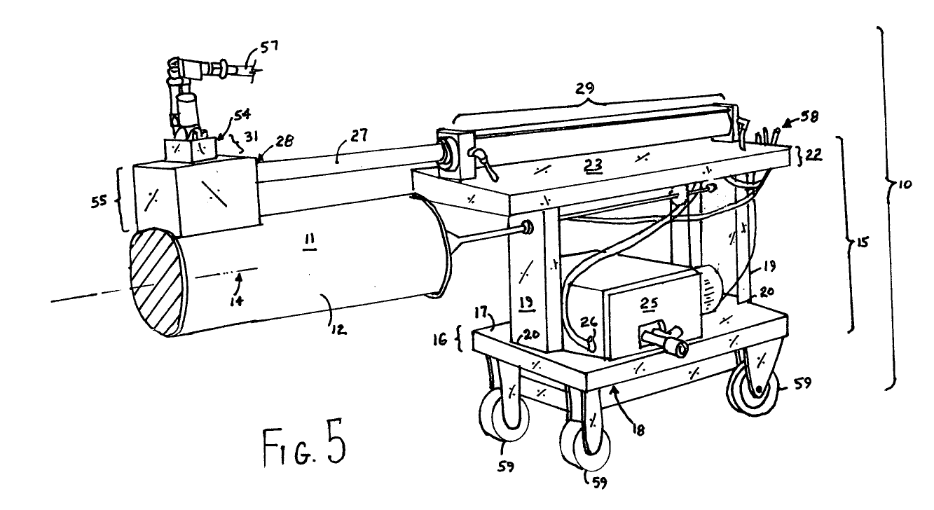

While FIG. 4 details an assembly with six nozzles (30), the number of nozzles (30) is not limited by the illustrations provided. The scope of this invention contemplates that a variety of configurations may be necessary to accommodate a variety of fiberglass filament winding machines or like environments.

As shown in FIG. 4, the movable platform (31), in certain embodiments, includes at least one impeller (54) for a rotational motion of the at least one high-pressure fluid-spraying nozzle (30).

The rotational motion of the at least one high-pressure fluid-spraying nozzle (30) is in a plane generally tangent to the exterior surface (12) of the collet (11). In certain embodiments, the at least one impeller (54) may be fluid-driven. In certain other embodiments, the at least one impeller (54) may be pneumatically-driven.

In certain embodiments, the movable platform (31) further includes a cowling (55) for covering the at least one high-pressure fluid-spraying nozzle (30). The cowling serves numerous purposes. The first purpose is to protect the nozzle (30) or its constituent assembly. Another purpose is to prevent the resulting spray of fluid emitted during operation. As it is common to have a number of fiberglass filament winding machines (62) operating in close proximity to one another, it is not desirable to have the cleaning process interfere with the operation of other winding machines (62). The third purpose addresses the safety of the operators of the apparatus: as this apparatus, and all cleaning operations of collets (11), generally involves the use of fluid under pressure as well as the opportunity for fiberglass and hardened binder to be airborne at high velocity, operators are frequently at risk of injury from flying shards of fiberglass or filament (63). The cowling (55) prevents much of the debris from posing a danger to an operator in proximity to the collet (11) being cleaned.

The drawing of the cowling (55) is merely illustrative. In certain embodiments, the edge of the cowling (55) follows closely the curvature of the collet (11) being cleaned. The closer the edge of the cowling (55) follows the curvature of the collet (11), the lesser the opportunity for debris to escape the cleaning zone directly under, or within the spray areas of, the nozzles (30). In operation of certain embodiments, the cowling (55) is also positioned 0.05″ to 2.00″ over the exterior surface (12) of the collet (11).

The extensible arm (27) is attached to the movable platform (31). Generally, the length of a collet (11) is greater than the spray area of the nozzles (30). In certain preferred embodiments, it is therefore desirable to move the at least one high-pressure fluid-spraying nozzle (30) along the length of the collet (11). The extensible arm (27) therefore extends from the apparatus (10) from the edge of the outward-facing end (13) down the length of the collet (11) in a path generally parallel to the longitudinal axis (14) of the collet (11).

In certain other embodiments, the extensible arm (27) is retractable. In some applications, it may be desirable to employ an extensible arm (27) which is retractable for a repeated or future use.

The extensible arm (27) is extended by a drive means (29). In certain embodiments, at least one end of the drive means (29) is mounted on the second top (29) of the generally horizontal upper support structure (22). While the at least one end of the drive means (29) is securely mounted, the distal end (28) of the extensible arm (27) is movable along a path indicated by the drive means (29). In certain embodiments, the path indicated by the drive means (29) may be curvilinear or otherwise non-linear, as the specific application requires.

The extensible arm (27) therefore may be in a variety of configurations. In certain embodiments, the extensible arm (27) is a pneumatically-driven cylinder (33). In certain other embodiments, the extensible arm (27) is a fluid-driven cylinder (36). In even other embodiments, the extensible arm (27) is a mechanically-extended shaft (37). In certain of these embodiments, the mechanically-extended shaft (37) is threaded.

The drive means (29) moves the extensible arm (27). In certain embodiments the drive means (29) is a pneumatically-driven cylinder (33), driven by a pneumatic source (34). The pneumatic source has an outlet (35), and is mounted on the first top (17) of the generally horizontal base (16).

Similarly to the extensible arm (27), the drive means (29) may be in a variety of configurations. In certain embodiments, the drive means (29) for moving the extensible arm (27) is a pneumatically-driven cylinder (33). In certain other embodiments, the drive means (29) for moving the extensible arm (27) is a fluid-driven cylinder (36). In even other embodiments, the extensible arm (27) is a mechanically-extended shaft (37). In certain of these embodiments, the mechanically-extended shaft (37) is threaded.

The high pressure fluid source (25) provides fluid under high pressure to the at least one high-pressure fluid spraying nozzle (30).

In one certain preferred embodiment as illustrated in the drawings, the high pressure fluid source (25) has an outlet (26) and is mounted on the first top (17) of the generally horizontal base (16). The high pressure fluid source (25) may be a pump or reservoir located on the frame (15). In certain embodiments, the high pressure fluid source (25) is located exterior to apparatus (10).

In certain embodiments, the pump or the high pressure fluid source (25) provides fluid at the rate of sixteen gallons per minute (16 gals/min). While the fluid pumped is generally liquid water at room temperature, or a mixture of water and air, the fluid may also be another suitable solvent,m as the cleaning requirements dictate.

In certain embodiments, the fluid employed is under pressure ranging generally from 5,000 pounds per square inch (5 Kpsi) to 40,000 pounds per square inch (40 Kpsi). Depending on the fluid employed, the pressure, and even temperature, may vary according to the particular clean application desired.

The apparatus of this invention further includes a means (32) for rotating the collet (11). Rotating the collet (11) as a constant speed while providing a constant pressure of fluid at a consistent distance over the exterior surface (12) of the collet (11) entails that the cleaning provided by the apparatus (10) is consistent. While the speed of rotation of the collet (11) is variable, the rotation during cleaning is an element of this invention.

This certain embodiment includes a means (32) for rotating the collet (11). The collet (11) rotates around its longitudinal axis (14). In certain other embodiments, the means (32) for rotating the collet (11) is a manually-operated handle.

In the preferred embodiment, the means (32) for rotating the collet (11) consists of a motor (40), a first sprocket (42), a chain (43), a second sprocket (43), and an engaging plate (47).

The motor (40) has at least one axle (41) and mounted on the first top (17) of the generally horizontal base (16). In certain other embodiments, the means (32) for rotating the collet (11) is an electric motor (40).

The first sprocket (42) is driven by the at least one axle (41) of the motor (40). The chain (43) is driven by the first sprocket (42). The second sprocket (43) has a first center (44) and a first axis (45) and is driven by the chain (43).

The engaging plate (47), has a second center (48) and a second axis (49), a radius (50), an underside (51), a collet-engaging side (52) and at least one collet-engaging nub (53). The collet-engaging nub includes a first center (45) of the second sprocket (44) is attached to the underside (51) of the engaging plate (47) at the second center (48). In operation, the elements are aligned so that the first axis (46) and the second axis (49) are collinear with the longitudinal axis (14) of the collet (11). In the normal course of operation, the collet-engaging nub (53) engages the outward-facing end (13) of the collet (11).

In one certain preferred embodiment, this invention includes a frame (15). The frame (15) is a mounting for the elements of the apparatus (10). The frame (15) has a generally horizontal base (16), at least one vertically-extending rigid support member (19), and a generally horizontal upper support structure (22).

The generally horizontal base (16) of the frame (15) has a first top (17), and a first bottom (18). As illustrated by the drawings, wheels or casters (59) attached to the first bottom (18) support the frame (15) and permit the apparatus (10) to be mobile for appropriate positioning to the collet (11) to be cleaned. In certain embodiments, not shown by the drawings, mobility-enabling means other than wheels, and including motorized or automated transportation elements may permit the ready positioning of the apparatus (10).

The at least one vertically-extending rigid support member (19) has a lower end (20) and an upper end (21). The lower end (20) is attached to the first top (17) of the generally horizontal base (16). While the drawings illustrate that two support members (19) are employed, the scope of the invention is not limited by the illustrations provided.

The generally horizontal upper support structure (22) has a second top (23) and a second bottom (24). This structure (22) is the platform upon which the extensible arm (27), drive means (29) as well as any operator-related control means are generally located.

This invention is also an improved method for cleaning a collet (11).

The first step in this method consists of moving the extensible arm (27), with a distal end (28), to at least one position over the exterior surface (12) of the collet (11) by a drive means (29).

The next step in this method consists of positioning the extensible arm (27) over the collet (11), whereby at least one outlet (56) of at least one high-pressure fluid-spraying nozzle (30) is located over the exterior surface (12) of the collet (11).

In certain aspects of this method, the positioning of the extensible arm (27) is along a line of travel parallel to the longitudinal axis (14) of the collet (11).

In certain aspects of this method, the extensible arm (27) further consists of a movable platform (31) located at the distal end (28) of the extensible arm (27) such that the at least one high-pressure fluid spraying nozzle (30) is attached to the movable platform (31).

In certain aspects of this method, the positioning of the at least one high-pressure fluid-spraying nozzle (30) is along a line of travel parallel to the longitudinal axis (14) of the collet (11).

The next step in this method consists of spraying the exterior surface (12) of the collet (11) with a high-pressure fluid, through the at least one outlet (56) of the at least one high pressure fluid spraying nozzle (30).

The next step of this method consists of providing a high pressure fluid source (25) which is in fluid communication with the at least one high-pressure fluid spraying nozzle (30).

In certain aspects of this method, the collet (11) is rotated around the longitudinal axis (14) such that the exterior surface (12) of the collet (11) is in proximity to the high pressure fluid expelled from the at least one outlet (56) of the at least one high-pressure fluid spraying nozzle (30).

I claim:

1. An improved collet cleaning apparatus comprising:
at least one high-pressure fluid-spraying nozzle for spraying an exterior surface of a collet, the high pressure fluid spraying nozzle mounted on a movable platform;
an extensible arm, attached to the movable platform;
a drive means for moving the extensible arm;
a high pressure fluid source for providing fluid under high pressure to the at least one high-pressure fluid spraying nozzle; and,
a means for rotating the collet.

2. The apparatus of claim 1, wherein
the movable platform comprises at least one impeller for a rotational motion of the at least one high-pressure fluid-spraying nozzle.

3. The apparatus of claim 2, wherein
the rotational motion of the at least one high-pressure fluid-spraying nozzle is in a plane tangent to the surface of the collet.

4. The apparatus of claim 2, wherein
the at least one impeller is fluid-driven.

5. The apparatus of claim 2, wherein
the at least one impeller is pneumatically-driven.

6. The apparatus of claim 1, wherein
the movable platform further comprises a cowling for covering the at least one at least one high-pressure fluid-spraying nozzle.

7. The apparatus of claim 1, wherein
the extensible arm is a pneumatically-driven cylinder.

6. The apparatus of claim 1, wherein
the extensible arm is a fluid-driven cylinder.

7. The apparatus of claim 1, wherein
the extensible arm is a mechanically-extended shaft.

8. The apparatus of claim 8, wherein
the mechanically-extended shaft is threaded.

9. The apparatus of claim 1, wherein
the drive means for moving the extensible arm is a pneumatically-driven cylinder.

10. The apparatus of claim 1, wherein
the drive means for moving the extensible arm is a fluid-driven cylinder.

11. The apparatus of claim 1, wherein
the means for rotating the collet is an electric motor.

12. The apparatus of claim 1, wherein
the means for rotating the collet is a manually-operated handle.

13. An improved apparatus for cleaning a collet with an exterior surface, an outward-facing end and a longitudinal axis comprising:
a frame, with
a generally horizontal base, with a first top, and a first bottom, at least one vertically-extending rigid support member, with a lower end and an upper end, the lower end attached to the first top of the generally horizontal base, and
an generally horizontal upper support structure, with a second top and a second bottom;
a high pressure fluid source,
with an outlet, and
mounted on the first top of the generally horizontal base;
at least one high-pressure fluid-spraying nozzle
for spraying the exterior surface of the collet, the high pressure fluid spraying nozzle mounted on a movable platform, and
being in fluid communication with the outlet of the high pressure fluid source;
an extensible arm,
with a distal end on which his mounted the movable platform of the at least one high-pressure fluid-spraying nozzle, and
extended by a drive means; and,
a means for rotating the collet around the longitudinal axis.

14. The apparatus of claim 13, wherein
the drive means is mounted on the second top of the generally horizontal upper support structure

15. The apparatus of claim 14, wherein
the drive means is a pneumatically-driven cylinder, driven by a pneumatic pump,
with an outlet, and
mounted on the first top of the generally horizontal base.

16. The apparatus of claim 13, wherein
the extensible arm is retractable.

17. The apparatus of claim 13, wherein
the means for rotating the collet comprises
a motor, with at least one axle and mounted on the first top of the generally horizontal base,
a first sprocket, driven by the axle of the motor,
a chain, driven by the first sprocket,
a second sprocket, with a first center and a first axis, driven by the chain, an engaging plate, with a second center and a second axis, a radius, an underside, a collet-engaging side and at least one collet-engaging nub, wherein
the first center of the second sprocket is attached to the underside of the engaging plate at the second center so that the first axis and the second axis are collinear with the longitudinal axis of the collet, and
the at least one collet-engaging nub engages the outward-facing end of the collet.

18. A method for cleaning a collet with an exterior surface and a longitudinal axis, the method comprising:
moving an extensible arm, with a distal end, to at least one position over the exterior surface of the collet by a drive means;
positioning the extensible arm over the collet, whereby at least one outlet of at least one high-pressure fluid-spraying nozzle is located over the exterior surface of the collet;
spraying the exterior surface of the collet with a high-pressure fluid, through the at least one outlet of the at least one high pressure fluid spraying nozzle; and,
providing a source of high pressure fluid which is in fluid communication with the at least one high-pressure fluid spraying nozzle.

19. The method of claim 18, wherein
the extensible arm further comprises a movable platform located at the distal end of the extensible arm such that the at least one high-pressure fluid spraying nozzle is attached to the movable platform.

20. The method of claim 18, wherein
the positioning of the extensible arm is along a line of travel parallel to the longitudinal axis of the collet.

21. The method of claim 18, wherein
the positioning of the at least one high-pressure fluid-spraying nozzle is along a line of travel parallel to the longitudinal axis of the collet.

22. The method of claim 18, wherein
the collet is rotated around the longitudinal axis such that the exterior surface of the collet is in proximity to the high pressure fluid expelled from the at least one outlet of the at least one high-pressure fluid spraying nozzle.
